(19) United States
(12) Patent Application Publication
(10) Pub. No.: US 2014/0284257 A1
(43) Pub. Date: Sep. 25, 2014

(54) FILTER APPARATUS UTILIZING PRESSURIZED REVERSE CLEANING BY MEANS OF A FILTER DRUM

(71) Applicant: KOREA FILTER CO., LTD., Busan (KR)

(72) Inventor: Byung-keun Park, Busan (KR)

(73) Assignee: KOREA FILTER CO., LTD., Busan (KR)

(21) Appl. No.: 14/289,976

(22) Filed: May 29, 2014

Related U.S. Application Data
(63) Continuation of application No. PCT/KR2012/003207, filed on Apr. 26, 2012.

(30) Foreign Application Priority Data
Nov. 29, 2011 (KR) 10-2011-0125848

(51) Int. Cl. B01D 29/66; B01D 29/52; B01D 29/23

(52) U.S. Cl. CPC B01D 29/668; B01D 29/23; B01D 29/52
USPC 210/105; 210/108

(57) ABSTRACT

A filter apparatus utilizing pressurized reverse cleaning by a filter drum includes: a housing including an inlet and an outlet through which fluid enters and exits; a filtering means including a top plate and a bottom plate disposed apart at the top and bottom inside the housing and each forming a plurality of through holes in the circumferential direction thereof, wherein a plurality of filter drums formed in a cylindrical shape open at the top and bottom and have both ends coupled to the through holes of the top plate and the bottom plate so as to vertically communicate the plates, and wherein a filter element housed in each filter drum filters the fluid that enters; and a filter cleaning means including a supply pipe, a cylinder pressurizing the fluid and supplying the fluid to the lower portion of the supply pipe, an upper branch installed rotatably at the upper portion of the filter drum and defining a spray conduit therein , and a lower branch installed to rotate together with the upper branch and defining a discharge conduit therein.

### REFERENCE TO RELATED APPLICATIONS

This is a continuation of pending International Patent Application PCT/KR2012/003207 filed on Apr. 26, 2012, which designates the United States and claims priority of Korean Patent Application No. 10-2011-0125848 filed on Nov. 29, 2011, the entire contents of which are incorporated herein by reference.

### FIELD OF THE INVENTION

The present invention relates, in general, to self-cleaning filter apparatuses and, more particularly, to a filter apparatus in which a filter is automatically cleaned by pressurization of a cylinder.

### BACKGROUND OF THE INVENTION

Generally, transferring fluid such as a gas or a liquid is required in most production processes as well as in a variety of industrial facilities.

Foreign substances contained in fluids have great influence on the yield and performance of the production processes.

Therefore, there is a need for filtering such fluids to provide high-purity fluid.

However, filters are reduced in efficiency under insufficient pressure. In addition, over time, meshes of filters become clogged. If a filter is clogged, it is necessary to clean the filter; which usually requires the interruption of the operation of an associated apparatus, thus greatly reducing the processing efficiency.

Replacing a filter with a new one also requires interrupting the operation of the associated apparatus. Also, the replacement of the filter incurs costs, resulting in an increase in maintenance cost.

In an effort to overcome the above-mentioned problems, a filter system was proposed in Korean Patent Registration No. 10-1054236 (Jul. 29, 2011), entitled “Self-cleaning filter system” (hereinafter, referred to as a ‘prior art’). FIG. 1 is a perspective view showing the conventional self-cleaning filter system.

The self-cleaning filter system according to the prior art includes a filter body 10, a cylinder 20, a first 3-way valve 30 and a second 3-way valve 40. The filter body 10 includes: an inlet through which fluid is drawn into the filter body; a plurality of filter elements 13 through which the drawn fluid passes; a plurality of element drums 14a which enclose the respective filter elements 13 and is configured such that when one of them is selected, it is used for cleaning the corresponding filter element 13; branches 15 which are connected to each other, respectively provided in upper and lower portions of the filter body 10, and connected to one of the element drums 14a that is selected for self-cleaning; and an outlet through which fluid used for filtering is discharged out of the filter body 10. The cylinder 20 is provided in the filter body 10. When self-cleaning operation is conducted, fluid that has been in a front portion of the cylinder 20 is drawn under pressure into an upper portion of the filter body 10 and then supplied into an upper end of the selected element drum 14a, and fluid that has been in a lower end of the selected element drum 14a is sucked into a rear end of the cylinder 20. The first 3-way valve 30 is provided on a sidewall of the filter body 10. A first shaft of the first 3-way valve 30 is connected to the filter body 10, a second shaft thereof is connected to the cylinder 20, and a third shaft thereof is connected to the upper portion of the filter body 10. When the self-cleaning operation is conducted, the second shaft and the third shaft of the first 3-way valve 30 are connected to each other. The second 3-way valve 40 is provided on a sidewall of the filter body 10. A first shaft of the second 3-way valve 40 is connected to the filter body 10, a second shaft thereof is connected to the cylinder 20, and a third shaft thereof is connected to a drain tank. When the self-cleaning operation is conducted, the first shaft and the second shaft of the second 3-way valve 40 are connected to each other.

In the prior art, the filter elements can be automatically cleaned in such a way that the cylinder applies pressure to the filter elements. Therefore, the cleaning function is enhanced, and a pulsation phenomenon which may be caused in self-cleaning, can be prevented. Furthermore, as needed, the frequency of self-cleaning can be controlled. The amount of fluid used for self-cleaning and discharged to the outside can be minimized.

However, the amount of cleaning fluid discharged from the cylinder during a single process is limited. Thus, the filter element may not be satisfactorily cleaned in a single cycle, whereby the cylinder may be forced to be repeatedly operated. This increases the time it takes to complete the self-cleaning operation.

### SUMMARY OF THE INVENTION

Accordingly, the present invention has been made keeping in mind the above problems occurring in the prior art, and an object of the present invention is to provide a filter apparatus utilizing pressure reverse-cleaning by means of a filter drum, the filter apparatus including a check valve and being configured such that not only fluid for cleaning a filter but also filtered fluid, can be used as fluid for self-cleaning by internal pressure.

In order to accomplish the above object, the present invention provides a filter apparatus utilizing pressure reverse-cleaning by means of a filter drum, including: a housing having an inlet and an outlet through which fluid is drawn into and discharged from the housing; a filtering means having a top plate and a bottom plate disposed at upper and lower positions spaced apart from each other in the housing, each of the top plate and the bottom plate having a plurality of through holes, formed at positions circumferentially spaced apart from each other at regular angular intervals, a plurality of filter drums each having a cylindrical shape and being open on upper and lower ends thereof, the upper and lower ends of the filter drums being respectively coupled to the through holes of the top and bottom plates so that each of the through holes communicates with the corresponding through hole, and a filter element housed in each of the filter drums, the filter element filtering fluid drawn into the filter drum; and a filter cleaning means having a supply pipe passing through central portions of the top and bottom plates, a cylinder pressurizing fluid and supplying the fluid into a lower end of the supply pipe, an upper branch provided above the filter drums, the upper branch being rotated by a motor, with an injection passage formed in the upper branch, the injection passage communicating with the supply pipe, and a lower branch provided below the filter drums and configured so as to be rotatable along with the upper branch, with a discharge passage formed in the lower branch, wherein the upper and lower branches rotate and seals the upper and lower ends of one of the filter drums, and fluid supplied from the cylinder is injected into the selected filter drum through the injection passage to clean the corresponding filter element and then discharged out of the filter drum through the discharge passage, and a check valve is provided on the upper branch, the check valve being opened by pressure of fluid in the housing so that fluid is drawn into the injection passage.

The filter apparatus may further include a control means for controlling rotation of the motor so that the upper branch and the lower branch can be respectively located at precise positions corresponding to the desired through holes.

The control means may include: a first disc having a plurality of arc-shaped notches formed apart from each other at regular intervals in a peripheral edge of the first disc; a sensor disposed above an upper surface of the first disc, the sensor sensing whether one of the arc-shaped notches is present in front of the sensor; a rotating arm provided above the first disc and rotated by the motor; a protrusion rod protruding downwards from each of opposite ends of the rotating arm, the protrusion rod entering a corresponding one of the arc-shaped notches and pushing the first disc, thus rotating the first disc; and a first controller receiving a signal from the sensor and controlling rotation of the motor.

The control means may include: a second disc having a plurality of contact protrusion protruding upwards from the second disc at positions circumferentially spaced apart from each other at regular intervals; a contact rod disposed above the second disc, the contact rod being rotated when making contact with one of the contact protrusions and then returned to an original state thereof; and a second controller controlling rotation of the motor in response to a contact signal of the contact rod.

The filter apparatus may further include a flow rate control rod provided in each of the filter elements. The flow rate control rod may be tapered such that a cross-sectional area thereof is gradually increased from an upper end thereof to a lower end.

A drain valve may be connected to the lower branch. The drain valve may communicate with the discharge passage so that fluid used for cleaning the filter element is discharged through the drain valve.

The cylinder may be configured such that a space ahead of a piston is connected to an upper portion of the housing so that the cylinder receives fluid for cleaning from the housing, and a space behind of the piston is connected to a lower portion of the housing so that a pressurizing force of the piston is increased.

Embodiments according to the present invention have the following effects.

First, a filter apparatus according to the present invention has a simple structure, whereby the production cost can be reduced. Even when filtering fluid, as needed, a selected one of the filters can be cleaned. Therefore, it is not required to interrupt the entire process of an associated apparatus even when there is a need for cleaning the filters or replacing them with new ones. As a result, the associated apparatus can be efficiently used. Self-cleaning the filters can markedly reduce the costs required for replacement or maintenance of the filters.

Second, a check valve is installed on an upper branch so that additional cleaning fluid, as well as fluid supplied from a cylinder, can be provided. Thereby, a selected filter element can be easily cleaned in a single cycle.

Third, a flow rate control rod is installed in each filter element, so that not only an upper end of the filter element, but even a lower end thereof can also be reliably cleaned.

### BRIEF DESCRIPTION OF THE DRAWINGS

FIG. 1 is a perspective view illustrating a conventional self-cleaning filter system;

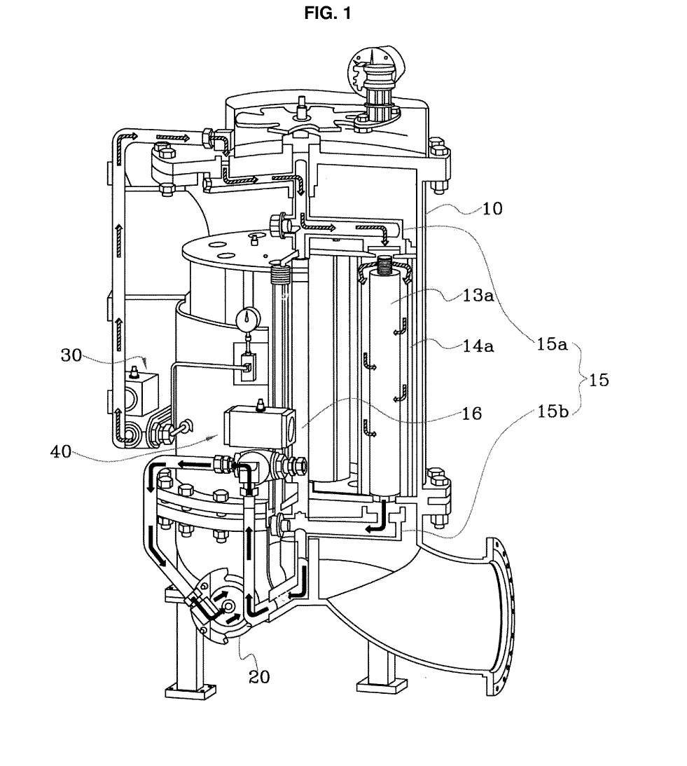

FIG. 2 is a broken perspective view illustrating a filter apparatus utilizing pressure reverse-cleaning by means of a filter drum according to a preferred embodiment of the present invention;

FIGS. 3(a) and 3(b) are views showing the construction of a control means according to the present invention;

FIG. 4 is a sectional view showing a flow rate control rod according to the present invention;

FIG. 5 is a view showing a process of filtering fluid according to the present invention;

FIG. 6 is a view showing a process of cleaning the filter according to the present invention; and

FIG. 7 is a schematic view showing the principle of supplying water to a cylinder.

### DETAILED DESCRIPTION OF THE INVENTION

Hereinafter, a preferred embodiment of the present invention will be described in detail with reference to the attached drawings. The embodiment just aims to help those with ordinary knowledge in this art more clearly understand the present invention rather than aiming to limit the bounds of the present invention. If in the specification, detailed descriptions of well-known functions or configurations would unnecessarily obfuscate the gist of the present invention, the detailed descriptions will be omitted.

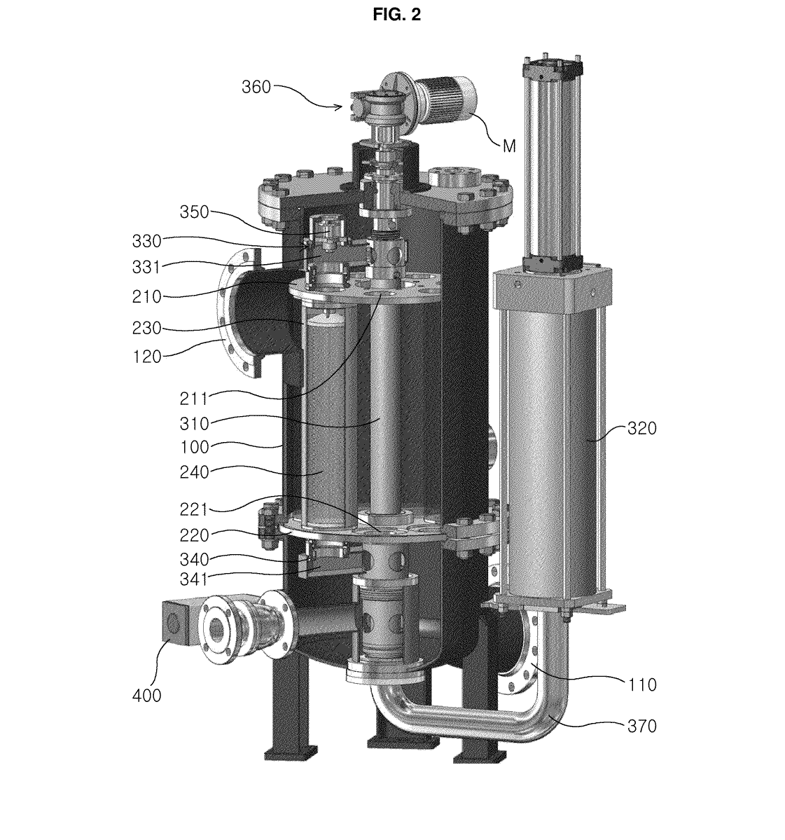

FIG. 2 is a broken perspective view illustrating a filter apparatus utilizing pressure reverse-cleaning by means of a filter drum according to a preferred embodiment of the present invention.

Referring to the drawing, the present invention includes a housing 100, a filtering means 200 and a filter cleaning means 300. The filter cleaning means 300 includes a check valve 350.

The housing 100 has a container shape, having a space therein. An inlet 110 through which contaminated fluid is drawn into the housing 100 is formed in a predetermined portion of a lower end of the housing 100. An outlet 120 through which filtered fluid is discharged out of the housing 100 is formed in a predetermined portion of an upper end of the housing 110. However, the present invention is not limited to this structure. As needed, fluid may be drawn into the housing through the outlet 120 and discharged out of the housing through the inlet 110.

The filtering means 200 is installed in the housing 100 so as to filter contaminated fluid that is drawn into the housing 100 through the inlet 110 and discharge filtered fluid out of the housing 100 through the outlet 120.

For this, as shown in drawings, the filtering means 200 includes a top plate 210, a bottom plate 220, a plurality of filter drums 230 and filter elements 240 which are housed in the respect filter drums 230.

The top plate 210 and the bottom plate 220 are disposed apart from each other in the housing 100, each of which horizontally partitions the space in the housing 100 into upper and lower spaces. Each of the top and bottom plates 210 and 220 has a plurality of through holes 211, 221 which are formed at positions circumferentially spaced apart from each other at regular angular intervals. The through holes 211 and 221 of the top plate 210 and the bottom plate 220 are respectively disposed at positions corresponding to each other with respect to the vertical direction.

Each filter drum 230 has a cylindrical shape. Both ends of the filter drum 230 are respectively coupled to the corresponding through holes 211 and 221 of the top plate 210 and the bottom plate 220. That is, each filter drum 230 communicates one through hole 211 of the top plate 210 with the corresponding through hole 221 of the bottom plate 220.

The filtering elements 240 are housed in the respective filtering drums 230. Each filtering element 240 functions to remove foreign substances from contaminated fluid. Preferably, the filter element 240 has an open bottom structure, in which a lower end thereof is open while an upper end thereof is covered with a cover, so that fluid to be filtered is drawn through the lower end of the filter element 240.

The filter cleaning means 300 is rotatably provided in the housing 100 above the top plate 210 and below the bottom plate 220. The filter cleaning means 300 selects one among the filter drums 230 and cleans the filter element 240 provided in the selected filter drum 230.

In detail, the filter cleaning means 300 includes a supply pipe 310, a cylinder 320, an upper branch 330 and a lower branch 340. The filter cleaning means 300 may further include a control means 360.

The supply pipe 310 passes through the central portions of the top and bottom plates 210 and 220. Cleaning fluid that is supplied from the cylinder 320 flows through the supply pipe 310.

The cylinder 320 is installed at a predetermined position adjacent to the housing 100 and communicates with the supply pipe 310 by a connection pipe 370 so that cleaning fluid is pressurized and supplied to the supply pipe 310 by piston motion of the cylinder 320.

The upper branch 330 is installed above the top plate 210 and can be rotated by a motor M. An injection passage 331 is formed in the upper branch 330. The upper branch 330 has an approximate L-shape. The injection passage 331 of the upper branch 330 communicates with the supply pipe 310. The upper branch 330 is operated in such a way that the injection passage 331 is connected to one among the filter drums 230 and then fluid that is supplied to the supply pipe 310 is injected into the selected filter drum 230 through the injection passage 331.

The lower branch 340 is installed below the bottom plate 220 and can be rotated, along with the upper branch 330, by the motor M. A discharge passage 341 is formed in the lower branch 330. The lower branch 340 also has an approximate L-shape. Fluid that is discharged from the filter drum 230 is drawn into the discharge passage 341 and then discharged to the outside through the discharge passage 341.

The check valve 350 that is a technical core of the present invention is installed in the upper branch 330.

The check valve 350 is a technical means which allows fluid to flow in only one direction. In this embodiment, the check valve 350 allows fluid to flow only in a direction from the outside to the inside of the upper branch 330, in other words, allows fluid to be drawn into the injection passage 331 but, with regard to the opposite direction, prevents fluid from being discharged out of the upper branch 330 from the injection passage 331.

This can remedy the conventional problem in which there has been a need for the cylinder 320 being repeatedly operated when the amount of fluid to be supplied for cleaning in a single cycle is not sufficient. In the present invention, some of filtered fluid that is in the housing 100 can be drawn into the injection passage 331 through the check valve 350 by pressure, thus supplementing the amount of cleaning fluid supplied from the cylinder 320, thereby assisting in cleaning the filter element 240.

The upper and lower branches 330 and 340 can be rotated by the motor M. The motor M is controlled by the control means 360. In this embodiment, controlled by the control means 360, the motor M precisely locates the injection passage 331 and the discharge passage 341 of the upper and lower branches 330 and 340 to the respective through holes 211 and 221 that are associated with a desired filter drum 230 to be cleaned.

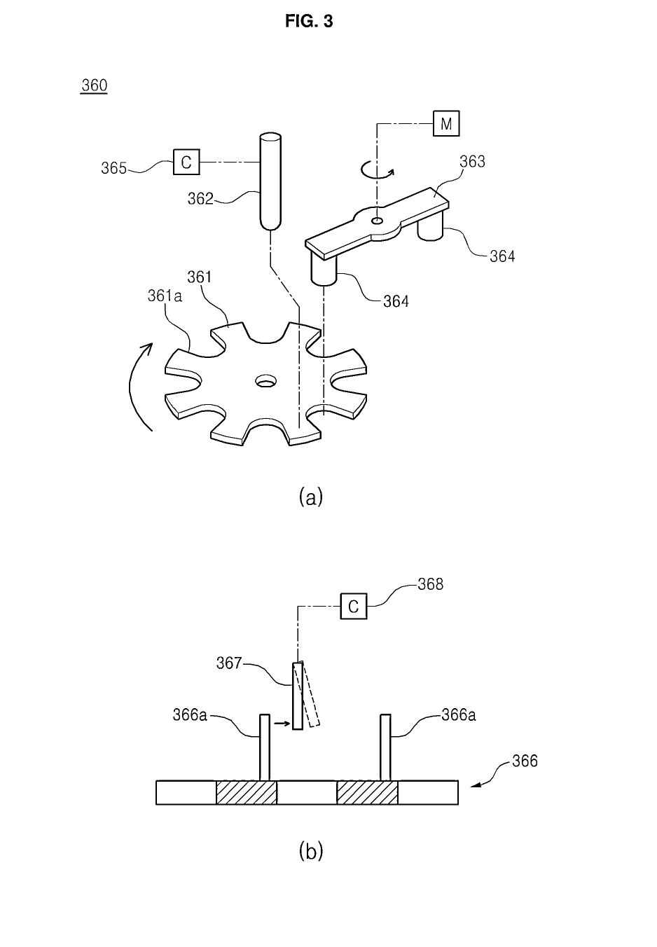

The control means will be explained in more detail with reference to FIG. 3. FIG. 3 is a view showing the construction of the control means according to the present invention.

As shown in FIG. 3(a), the control means 360 may include a first disc 361, a sensor 362, a rotating arm 363, protrusion rods 364 and a first controller 365.

Notches 361a are formed in an outer circumferential edge of the first disc 361 at positions spaced apart from each other at regular intervals. Each notch 361 a has an arc shape, which is formed towards the center of the first disc.

The sensor 362 is disposed above the first disc 361 to sense whether any notch 361a is present in front of the sensor 362.

The rotating arm 363 has a planar shape and is rotated by the motor M. The rotating arm 363 is disposed above the first disc 361. The protrusion rods 364 protrude downwards from respective opposite ends of the rotating arm 363 and can be removably inserted into the notches 361a.

The first controller 365 receives a signal from the sensor 362 and controls the rotation of the motor M based on the signal.

When the rotating arm 363 rotates, either protrusion rod 364 is inserted into a corresponding notch 361a of the first disc 361 and pushes the first disc 361, thus rotating the first disc 361.

As shown in the drawing, disposed above the upper surface of the first disc 361, the sensor 362 senses whether any notch 361a is present in front of it and transmits a corresponding signal to the first controller 365. The first controller 365 receives the signal from the sensor 362 and controls the rotation of the motor M.

Alternatively, as shown in FIG. 3(b), the control means 360 may include a second disc 366, contact rods 367 and a second controller 368.

The second disc 366 has a circular plate and is rotatably configured. The second disc 366 has a circular plate and is rotatably configured. Protruding upwards, contact protrusions 366a are provided on the second disc 366 at positions circumferentially spaced apart from each other at regular intervals.

The contact rod 367 is disposed above the second disc 366. When any one of the contact protrusions 366a makes contact with the contact rod 367, the contact rod 367 rotates and then returns to its original state.

The second controller 368 controls the rotation of the motor M in response to a signal generated when any one of the contact protrusions 366a makes contact with the contact rod 367.

As such, the control means 360 may be configured in such a way that the rotation of the motor M can be controlled using a signal generated upon making contact between the contact rod 367 and any one of the contact protrusions 366a. This configuration can bring the same effect as that of the configuration of FIG. 3(a).

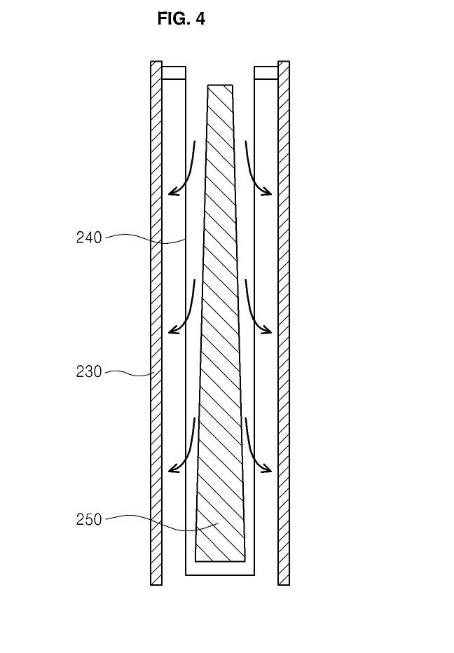

The filter apparatus according to the present invention may further include a flow rate control rod 250 which is provided in each filter element 240 to maintain the flow rate of cleaning fluid drawn into the filter element 240 constant. FIG. 4 is a sectional view showing the flow rate control rod according to the present invention.

As shown in the drawing, the flow rate control rod 250 is disposed in the filter element 240 and has a tapered shape which is increased in cross-sectional area from the top to the bottom.

Discharged from the injection passage 331 of the upper branch 330, cleaning fluid is supplied into a desired one of the filter elements 240. Flowing between the flow rate control rod 250 and an inner surface of the filter element 240, the cleaning fluid removes various foreign substances that have adhered to the inner surface of the filter element 240 therefrom and thus cleans the inner surface of the filter element 240, before being discharged out of the filter element 240.

Generally, the flow rate of fluid drawn into the upper end of the filter element 240 is reduced as it flows downwards. However, in this embodiment, because the flow rate control rod 250 has a tapered shape in such a way that the distance between the flow rate control rod 250 and the inner surface of the filter element 240 is reduced from the top to the bottom in the same manner as that of a nozzle, the flow rate of fluid can be prevented from being reduced according to Bernoulli's principle. Therefore, the entirety of the filter element 240 can be uniformly cleaned.

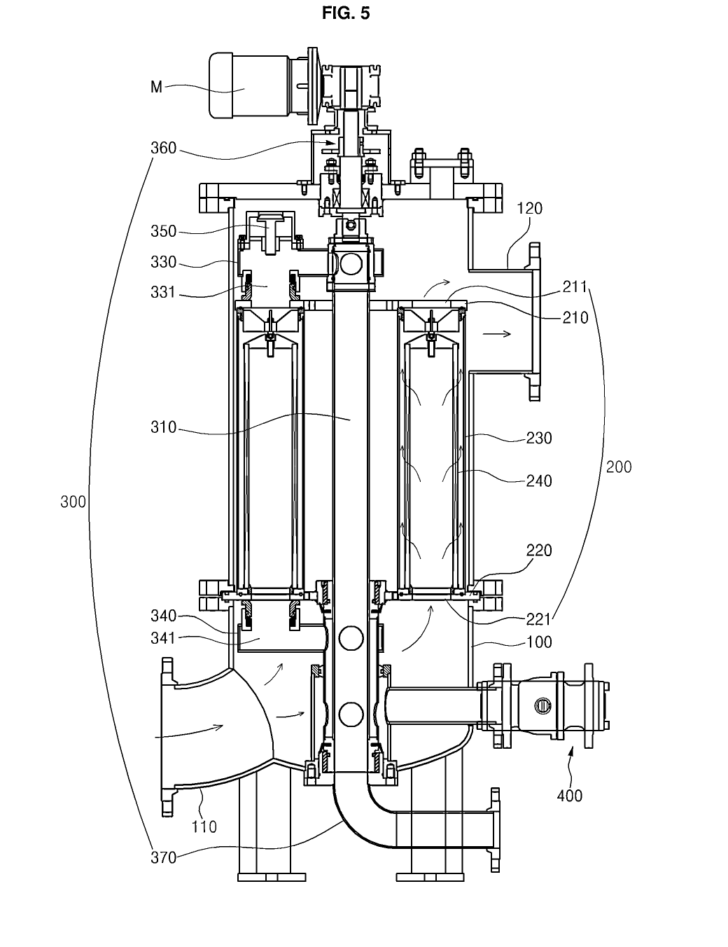

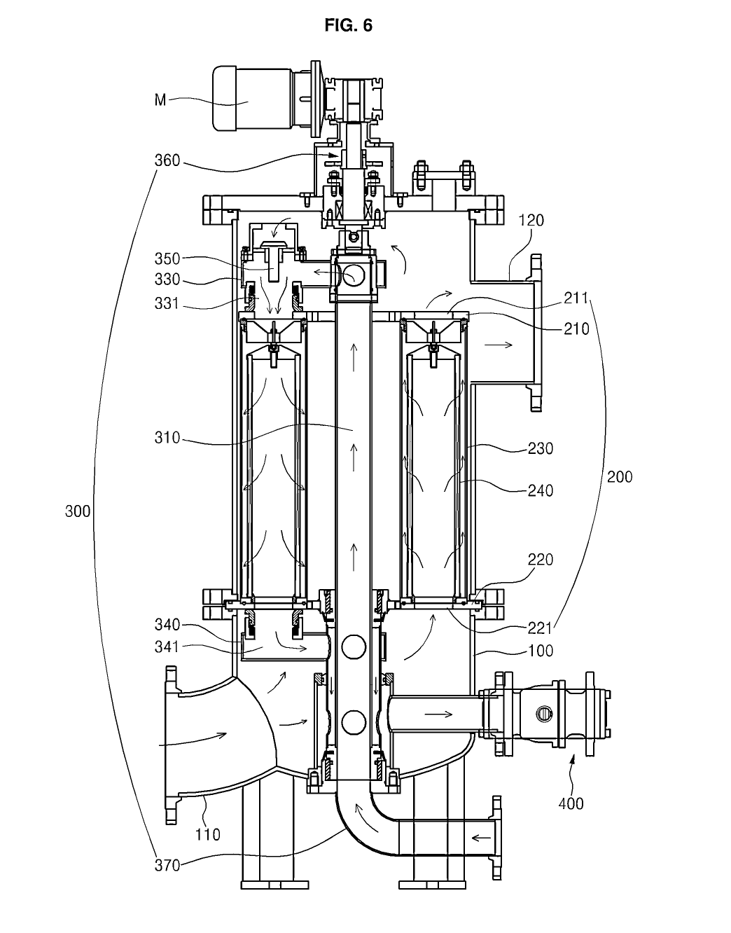

Hereinafter, the operation of the filter apparatus according to the present invention will be explained with reference to FIGS. 5 and 6. FIG. 5 is a view showing a process of filtering fluid according to the present invention. FIG. 6 is a view showing a process of cleaning the filter according to the present invention.

Referring to FIG. 5, with regard to a filtering process, polluted fluid drawn into the inlet 110 is supplied upwards into the filter drums 230 through the through holes 221 of the bottom plate 220.

The polluted fluid supplied into the filter drums 230 is filtered while passing through the filter elements 240. Thereafter, the fluid moved to the upper ends of the filter drums 230 is discharged to the outside through the outlet 120.

To clean a desired one among the filter elements 240 that have filtered polluted fluid, as shown in FIG. 6, the upper and lower branches 330 and 340 are rotated by the operation of the motor M so that the upper branch 330 is disposed on the upper end of the selected filter drum 230 and the lower branch 340 is disposed under the lower end of the first drum 230 such that the filter drum 230 is sealed.

Subsequently, a piston 321 that is disposed in the cylinder 320 is moved downwards so that cleaning fluid that has been stored in the cylinder 320 is injected into the selected filter drum 230 through the connection pipe 370, the supply pipe 310 and the injection passage 331. The fluid injected into the filter drum 230 enters the filter element 240 that is in the filter drum 230 and then cleans the filter element 240 while coming out of the filter element 240.

In an embodiment, a separate curved blade may be provided on the upper end of each filter drum 230, that is, on an inlet of the filter drum 230 into which fluid injected from the injection passage 331 is drawn, so that the fluid can swirl when entering the filter drum 230. This structure makes it more effective to clean the filter element, compared to the structure in which fluid enters the filter drum 230.

The fluid used for cleaning is discharged to the outside through the discharge passage 341. Preferably, the filtering apparatus further includes a drain valve 400 which communicates with the discharge passage 341 so that fluid that has been used for cleaning can be collected in a drain tank (not shown).

During the cleaning process, as illustrated in FIG. 6 and described above, some of fluid that has been filtered in the housing 100 is drawn into the filter drum through the check valve 350 and used for cleaning.

After the cleaning process has been completed, the upper and lower branches 330 and 340 can rotate again under the control of the control means 360 so as to clean another filter element 240.

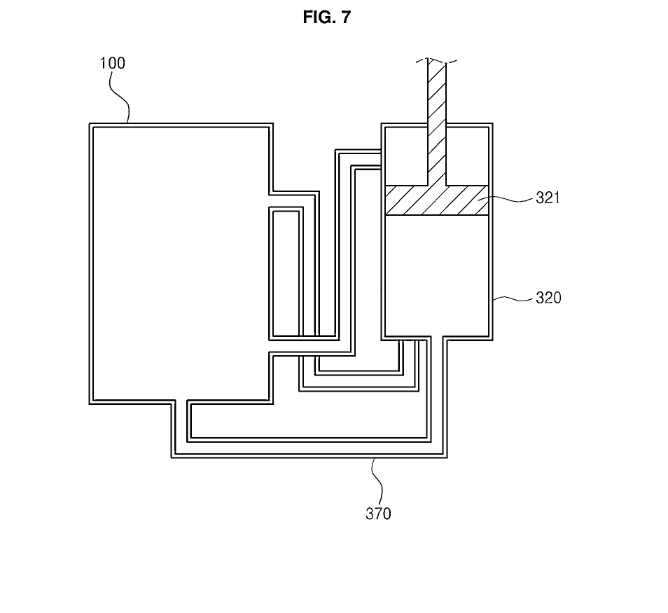

For reference, FIG. 7 is a view showing the principle of supplying water to a cylinder.

The cylinder 320 has the piston 321 which is used to pump fluid that is in the cylinder 320. An upper portion of the housing 100 is connected to a space ahead of the piston 321, that is, a space defined below the piston 321, so that filtered fluid that is in the upper portion of the housing 100 can be supplied into the cylinder 320 and then used for cleaning.

A lower portion of the housing 100 is connected to a space behind the piston 321, that is, a space defined above the piston 321, so that pre-filtered fluid that is in the lower portion of the housing 100 can be supplied into the space defined behind the piston 321, thus increasing the pressurizing force of the piston 321.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

As described above, the present invention relates to a filter apparatus having a self-cleaning function and can be usefully implemented in a field that pertains to a filter apparatus which can be automatically cleaned by pressurization of a cylinder.

What is claimed is:

1. A filter apparatus utilizing pressure reverse-cleaning by means of a filter drum, comprising:
a housing (100) having an inlet (110) and an outlet (120) through which fluid is drawn into and discharged from the housing (100);
a filtering means (200) comprising: a top plate (210) and a bottom plate (220) disposed at upper and lower positions spaced apart from each other in the housing (100), each of the top plate (210) and the bottom plate (220) having a plurality of through holes (211), (221) formed at positions circumferentially spaced apart from each other at regular angular intervals; a plurality of filter drums (230) each having a cylindrical shape and being open on upper and lower ends thereof, the upper and lower ends of the filter drums (230) being respectively coupled to the through holes (211) and (221) of the top and bottom plates (210) and (220) so that each of the through holes (211) communicates with the corresponding through hole (221); and a filter element (240) housed in each of the filter drums (230), the filter element (240) filtering fluid drawn into the filter drum (230); and
a filter cleaning means (300) comprising: a supply pipe (310) passing through central portions of the top and bottom plates (210) and (220); a cylinder (320) pressurizing fluid and supplying the fluid into a lower end of the supply pipe (310); an upper branch (330) provided above the filter drums (230), the upper branch (330) being rotated by a motor (350), with an injection passage (331) formed in the upper branch (330), the injection passage (331) communicating with the supply pipe (310); and a lower branch (340) provided below the filter drums (230) and configured so as to be rotatable along with the upper branch (330), with a discharge passage (341) formed in the lower branch (340),
wherein the upper and lower branches (330) and (340) rotate and seals the upper and lower ends of one of the filter drums (230), and fluid supplied from the cylinder (320) is injected into the selected filter drum (230) through the injection passage (331) to clean the corresponding filter element (240) and then discharged out of the filter drum (230) through the discharge passage (341), and
a check valve (350) is provided on the upper branch (330), the check valve (350) being opened by pressure of fluid in the housing (100) so that fluid is drawn into the injection passage (331).

2. The filter apparatus of claim 1, further comprising
a control means (360) for controlling rotation of the motor (350) so that the upper branch (330) and the lower branch (340) can be respectively located at precise positions corresponding to the desired through holes (211) and (221).

3. The filter apparatus of claim 2, wherein the control means (360) comprises: a first disc (361) having a plurality of arc-shaped notches (361a) formed apart from each other at regular intervals in a peripheral edge of the first disc (361); a sensor (362) disposed above an upper surface of the first disc (361), the sensor (362) sensing whether one of the arc-shaped notches (361a) is present in front of the sensor (362); a rotating arm (363) provided above the first disc (361) and rotated by the motor (350); a protrusion rod (364) protruding downwards from each of opposite ends of the rotating arm (363), the protrusion rod (364) entering a corresponding one of the arc-shaped notches (361a) and pushing the first disc (361), thus rotating the first disc (361); and a first controller (365) receiving a signal from the sensor (362) and controlling rotation of the motor (350).

4. The filter apparatus of claim 2, wherein the control means (360) comprises: a second disc (366) having a plurality of contact protrusion (366a) protruding upwards from the second disc (366) at positions circumferentially spaced apart from each other at regular intervals; a contact rod (367) disposed above the second disc (366), the contact rod (367) being rotated when making contact with one of the contact protrusions (366a) and then returned to an original state thereof; and a second controller (368) controlling rotation of the motor (350) in response to a contact signal of the contact rod (367).

5. The filter apparatus of claim 1, further comprising
a flow rate control rod (250) provided in each of the filter elements (240), the flow rate control rod (250) being tapered such that a cross-sectional area thereof is gradually increased from an upper end thereof to a lower end.

6. The filter apparatus of claim 1, wherein a drain valve (400) is connected to the lower branch (340), the drain valve (400) communicating with the discharge passage (341) so that fluid used for cleaning the filter element (240) is discharged through the drain valve (400).

7. The filter apparatus of claim 1, wherein the cylinder (320) is configured such that: a space ahead of a piston (321) is connected to an upper portion of the housing (100) so that the cylinder (320) receives fluid for cleaning from the housing (100); and a space behind of the piston (321) is connected to a lower portion of the housing (100) so that a pressurizing force of the piston (321) is increased.
